(19) United States
(12) Patent Application Publication
(10) Pub. No.: US 2011/0156634 A1
(43) Pub. Date: Jun. 30, 2011

(54) HYBRID POWER SUPPLY SYSTEM

(75) Inventor: CHIH-CHEN LAI, Tu-Cheng (TW)

(73) Assignee: HON HAI PRECISION INDUSTRY CO., LTD., Tu-Cheng (TW)

(21) Appl. No.: 12/820,334

(22) Filed: Jun. 22, 2010

(30) Foreign Application Priority Data
Dec. 25, 2009 (TW) 98144913

(51) Int. Cl. H01M 10/46

(52) U.S. Cl. 320/101

(57) ABSTRACT

A hybrid power supply system includes a solar panel, a rechargeable battery for receiving electrical energy from the solar panel, a line power port, a switch capable of electrically connecting the line power port and the rechargeable battery, and a power sensor for acquiring an electrical energy value from the rechargeable battery and a controller. The controller receives the electrical energy value from the power sensor, and controls the switch to electrically connect the line power port and the rechargeable battery when a voltage of the rechargeable battery falls below a predetermined value. The line power port charges the rechargeable battery to one full cycle of power output of the rechargeable.

### BACKGROUND

1. Technical Field

The present disclosure relates to hybrid power supply systems and, particularly, to a hybrid power supply system including solar and line power.

2. Description of the Related Art

Many lit outdoor signs or street lights use hybrid power systems. The lamps are light emitting device and powered by a rechargeable battery and the rechargeable battery is recharged by either solar power or line or grid power. Ideally, the rechargeable battery is recharged during the day by a solar panel and the line power is never used. Thereby saving the cost of the line power.

However, during the day, when conditions are overcast or cloudy, the battery is charged by the line power. If, during the same day, the sun comes out, and the battery is fully charged by the line power the energy from the solar panel is wasted.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout the views, and both the views are schematic.

FIG. 1 is a block diagram of a first embodiment of a hybrid power supply system.

FIG. 2 is a block diagram of a second embodiment of a hybrid power supply system.

### DETAILED DESCRIPTION

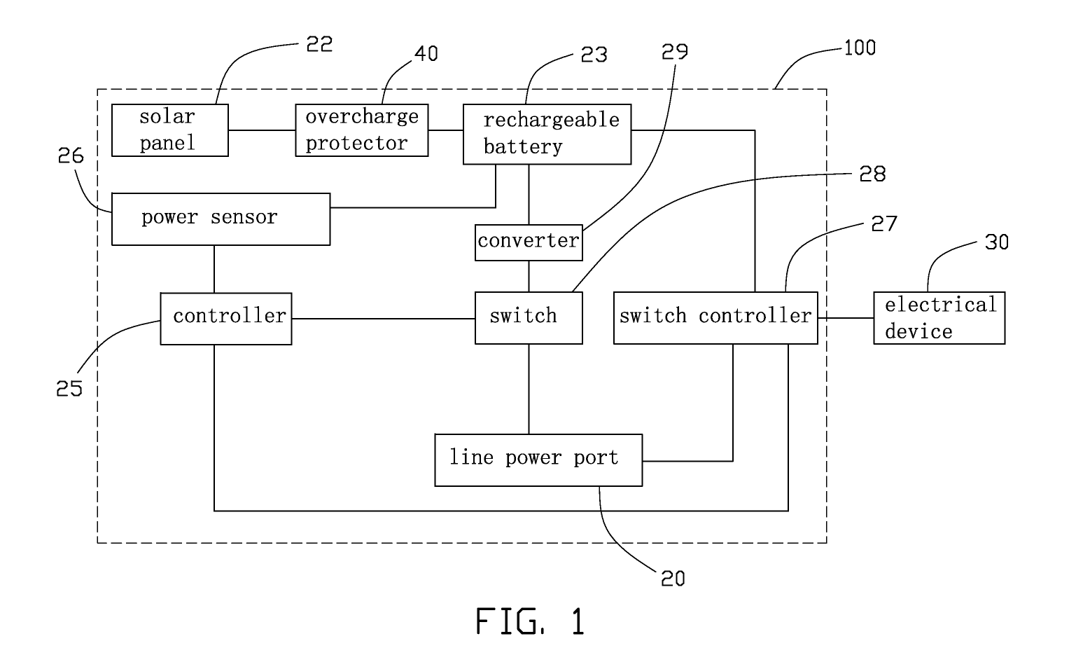

Referring to FIG. 1, a first embodiment of a hybrid power supply system 100 supplying electrical energy for an electrical device 30 includes a line power port 20, a solar panel 22, an rechargeable battery 23, a controller 25, a power sensor 26, a switch controller 27 and a switch 28. In the illustrated embodiment, the electrical device 30 is a street light/lamp.

The solar panel 22 converts solar energy to electrical energy, and outputs the electrical energy to the rechargeable battery 23 for storage. The power sensor 26 senses a voltage value and a current value and calculates an electrical energy value received by the rechargeable battery 23, and transmits the electrical energy value to the controller 25. On a cloudless day the electrical energy output of the solar panel 22 exceeds the maximum energy of the rechargeable battery 23. When the rechargeable battery 23 is fully charged, it is able to power the electrical device 30 beyond its usual cycle, that is, 12 hours or from dusk till dawn.

The switch controller 27 is a switch assembly, connected to the rechargeable battery 23, the electrical device 30, the line power port 20 and controller 25. The controller 25 controls the switch controller 27 to electrically connect the rechargeable battery 23 or the line power port 20 to the electrical device 30 selectively. That is, the power source for the electrical device 30 can be the rechargeable battery 23 or the line power port 20. The switch 28 is controlled by the controller 25. When the switch 28 is closed, the rechargeable battery 23 is connected with the line power port 20. When the electrical energy in the rechargeable battery 23 falls below a predetermined value, the switch 28 is closed by the controller 25. The line power port 20 supplies electrical energy to the electrical device 30 via the switch controller 27, and simultaneously charges the rechargeable battery 23.

During the day when the solar panel 22 receives direct sunlight, the electrical energy outputted by the solar panel recharges the rechargeable battery 23. During the night, the rechargeable battery 23 is connected to the electrical device 30, and supplies electrical energy thereto.

During an overcast or cloudy day, the solar panel 22 may not output enough electrical energy to charge the rechargeable battery 23 to power the electrical device 30 all night. Thus, when the voltage of the rechargeable battery 23 falls below a predetermined value, the line power port 20 is connected to the electrical device 30 via the switch controller 27, and the line power port 20 is also connected to the rechargeable battery 23 via the switch 28. The line power port 20 supplies electrical energy to the electrical device 30 and charges the rechargeable battery 23 simultaneously. When the rechargeable battery is charged to a certain voltage by the line power port 20, the controller 25 opens the switch 28, thus the rechargeable battery 23 is not fully charged by the line power port 20. The predetermined value is the energy value where the rechargeable battery is able to power the electrical device for a full cycle. In the event of non-overcast conditions during the next day, the electrical energy from the solar panel 22 will charge the rechargeable battery 23 beyond the predetermined charging capacity; and if the day is cloudless long enough the rechargeable battery 23 will be fully charged by the solar panel 22. Thus the hybrid power system 100 is able to maximize the use of the solar panel 22 and when an entire day is overcast and there is a line power failure, the electrical device 30 is still able to operate for at least one complete cycle.

The hybrid power supply system 100 further includes a converter 29 converting alternating current from the line power port 20 to direct current before output to the rechargeable battery 23.

The hybrid power supply system 100 further includes an overcharge protector 40. When the rechargeable battery 23 is full, the overcharge protector 40 stops charging from the solar panel 22.

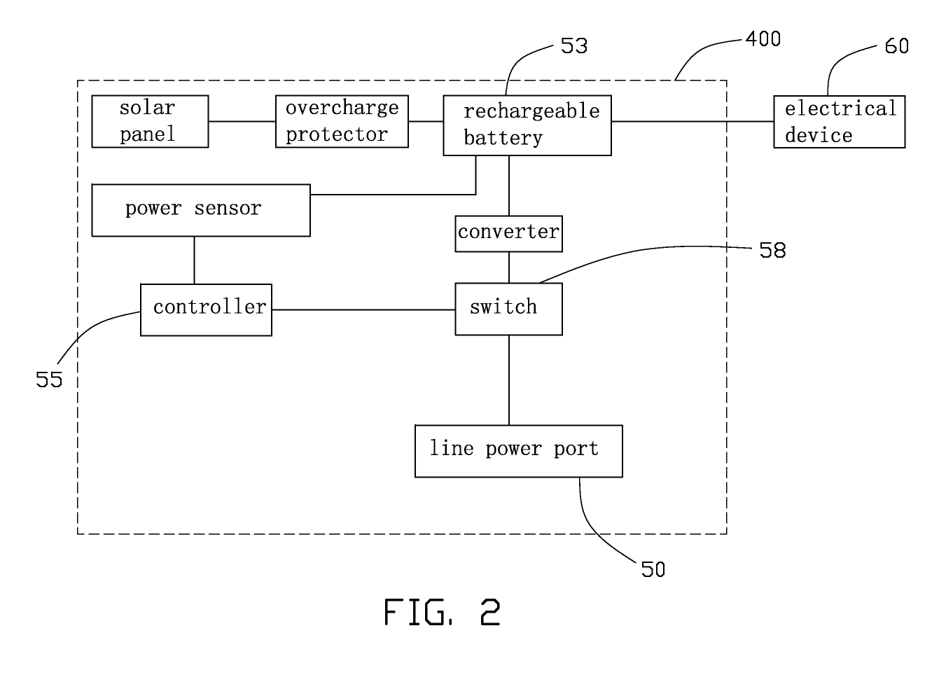

Referring to FIG. 2, a second embodiment of a hybrid power supply system 400 differs from the hybrid power supply system 100 in that the switch controller 27. In the hybrid power supply system 400 the rechargeable battery 53 is directly connected to the electrical device 60, and supplies electrical energy thereto. When the charge of the rechargeable battery falls below the predetermined value, the controller 55 closes the switch 58, and the line power port 50 charges the rechargeable battery 53.

While particular embodiments have been described, the description is illustrative and is not to be construed as limiting. For example, various modifications can be made to the embodiments by those of ordinary skill in the art without departing from the true spirit and scope of the invention as defined by the appended claims.

What is claimed is:

1. A hybrid power supply system comprising:
a solar panel;
a rechargeable battery for receiving electrical energy from the solar panel;
a line power port;
a switch capable of electrically connecting the line power port and the rechargeable battery;
a power sensor for acquiring an electrical energy value from the rechargeable battery; and
a controller receiving the electrical energy value from the power sensor, and controlling the switch to electrically connect the line power port and the rechargeable battery when a voltage of the rechargeable battery falls below a predetermined value, and the controller controlling the switch to electrically disconnect the line power port from the rechargeable battery when the charge on the rechargeable battery is equal to a power output cycle.

2. The hybrid power supply system of claim 1, further comprising an overcharge protector for the rechargeable battery.

3. The hybrid power supply system of claim 1, further comprising a converter for converting alternating current to direct current, which is input to the rechargeable battery.

4. A hybrid power supply system for an electrical device comprising:
a solar panel;
a rechargeable battery for receiving electrical energy from the solar panel, the rechargeable battery electrically connected to the electrical device;
a line power port;
a switch capable of electrically connecting the line power port and the rechargeable battery;
a power sensor for acquiring an electrical energy value from the rechargeable battery;
a switch controller capable of electrically connecting the line power port, the rechargeable battery and the electrical device selectively,
a controller receiving the electrical energy value from the power sensor and directing the switch controller to electrically connect the line power port and the electrical device, and the switch to electrically connect the line power port and the rechargeable battery when a voltage of the rechargeable battery falls below a predetermined value and to disconnect the line power port and the rechargeable battery when the charge on the rechargeable battery is equal to a power output cycle.

5. The hybrid power supply system of claim 4, further comprising an overcharge protector for the rechargeable battery.

6. The hybrid power supply system of claim 4, further comprising a converter for converting alternating current to direct current, which is then input to the rechargeable battery.
